(19) United States
(12) Patent Application Publication
(10) Pub. No.: US 2025/0360645 A1
(43) Pub. Date: Nov. 27, 2025

(54) PUNCHING DEVICE FOR PUNCHING OUT BLISTER PACKS FROM A BLISTER STRIP

(71) Applicant: Uhlmann Pac-Systeme GmbH & Co. KG, Laupheim (DE)

(72) Inventors: Wolfgang RODI, Laupheim (DE); Peter BORN, Laupheim (DE)

(21) Appl. No.: 19/219,214

(22) Filed: May 27, 2025

(30) Foreign Application Priority Data
May 27, 2024 (EP) 24178139.2

(51) Int. Cl. B26F 1/14; B65B 61/06

(52) U.S. Cl. CPC B26F 1/14; B65B 61/065

(57) ABSTRACT

A punching device for punching out blister packs from a blister strip having at least a first and a second punching element. The first punching element has at least one punch and the second punching element has a die. The first punching element is movable back and forth in a punching direction so that the punching device alternately assumes an open position and a closed position. At least one adjustment unit is associated with the punch and is configured to move the punch in the punching direction between an operating position and an offset position so that the punch is arranged further away from the second punching element in the offset position than in the operating position. The at least one adjustment unit has a force transmission element, which is adjustable in the punching direction in order to move the punch between the operating position and the offset position.

### CROSS-REFERENCE TO RELATED APPLICATIONS

This application claims the benefit of and priority under 35 U.S.C. § 119 to European Patent Application No. 24 178 139.2 filed May 27, 2024, the contents of which is incorporated herein by reference in its entirety.

### FIELD

The present disclosure relates to a punching device for punching out blister packs from a blister strip.

### BACKGROUND

The requirements for quality assurance and the technical possibilities for this are constantly increasing in the field of automated product manufacturing. One of the top priorities of quality assurance is to only deliver products to the customer that are free from defects and that also meet the agreed specifications. In the automated packaging of products in blister packs, such as tablets or other smaller items, it is key that the intended number of products per blister cavity is present after automated packaging and that the carrier film of the blister strip and also the sealing film are free from damage that could adversely affect the storage of the products to be packaged.

The process of automated packaging of products in blister packs is generally a continuous process. If a defect is detected in a process step, the affected point in the blister strip cannot be excluded from further processing and subsequent process steps. At the end of the automated packaging process, filled blister packs are punched out from the blister strip, separated, and packed into folding boxes. If the defective portions of the blister strip are punched out as blister packs, a separate subsequent ejection must take place. This is time-consuming and may also lead to errors.

Punching devices for punching blister packs generally have two interacting punching elements. The first punching element comprises the punch or punches and the second punching element comprises a die. The punches are usually moved into the die, whereas the die is stationary. The punches and the recesses of the die each have the contour of the blister pack to be punched, wherein the punches are slightly smaller in order to be spaced from the die within the recess of the die by means of a narrow, circumferential cutting gap. The cutting gap protects the two punching elements from wear, as direct mechanical contact between the two is prevented. The cutting gap must be set precisely, correspondingly, to ensure burr-free shearing of the blister pack from the blister strip. When a punch is moved into the die, it is guided by linear guides in the punching direction. These linear guides must only have a very small amount of play laterally to the punching direction, as otherwise the punch will tilt laterally to the punching direction beyond the tolerance of the cutting gap and come into direct contact with the die, damaging the die and the punch.

### SUMMARY

The present disclosure overcomes the above-mentioned disadvantages and provides an improved punching device which facilitates the ejection of defective portions of the blister strip and ensures precise punch guidance during the punching process.

According to an aspect of the present disclosure, the punching device for punching out blister packs from a blister strip comprises at least a first and a second punching element, wherein the first punching element has at least one, preferably a plurality of punches and the second punching element has a die. The first and/or the second punching element is movable back and forth in a punching direction in such a way that the punching device alternately assumes an open position and a closed position. The punching device furthermore has, for each punch, at least one adjustment unit associated with the punch, which adjustment unit is configured to move the punch, in addition to the movement of the at least one punching element, in the punching direction between an operating position and an offset position in such a way that the punch is arranged further away from the second punching element in the offset position than in the operating position. The at least one adjustment unit has a force transmission element, which is adjustable in the punching direction in order to move the punch between the operating position and the offset position.

The force transmission from the force transmission element of the adjustment unit to the punch is implemented directly in the punching direction.

The punching device ensures a selective, precise punching of blister packs. Due to the selective punching of blister packs, it is ensured that blister packs are only punched out from those regions of the blister strip that are free from defects. It is thus possible to prevent blister packs that do not correspond to the quality requirements from being fed mistakenly to subsequent packing steps or even from entering circulation.

The adjustment unit is preferably adjustable in precisely two positions. Simple mechanical adjustment units can be used for this purpose, the position of which in the punching direction does not have to be monitored and controlled.

The adjustment units, in the operating position, allow a punching of the blister strip, but in the offset position prevent a punching of the blister strip, even if the associated punching element is in the punching position. Defective portions of the blister strip therefore cannot be punched out selectively from the blister strip by means of the adjustment units, and only those portions that are free from defects are punched out as blister pack from the blister strip and fed to subsequent processing steps.

In a preferred embodiment, the force transmission element is pneumatically adjustable.

The at least one adjustment unit is particularly advantageously a pneumatic cylinder, preferably a double-acting pneumatic cylinder, which comprises the force transmission element in the form of a piston. The use of pneumatic cylinders as exchangeable and are quickly available as standardized replacement parts.

Generally, the force transmission element can be a piston, a spindle or a pin.

In a preferred embodiment, the magnitude of a stroke of the force transmission element deviates at most by 20%, preferably at most by 10%, particularly preferably at most by 5%, even more preferably not at all from an offset height of the associated punch between the operating position and the offset position. The construction is thus kept as simple as possible.

Preferably, the at least one adjustment unit is arranged in the punching direction between a lifting table of the punching device and a base plate of the first punching element.

The at least one adjustment unit can preferably be fastened to a lifting table of the punching device or integrated therein.

A stroke of the first punching element between the open position and the closed position of the punching device is preferably between 20 mm and 50 mm.

An offset height between the operating position and the offset position of a punch, brought about by the movement of the adjustment unit, is preferably between 5 mm and 10 mm.

In a preferred embodiment the punching device has a plurality of adjustment units one behind the other in the direction of travel of the blister strip and/or next to each other perpendicular to the direction of travel of the blister strip.

In an advantageous development, each adjustment unit is individually controllable. This measure makes it possible to adjust only individual punches in height. It is further conceivable to control the adjustment units in groups if a plurality of adjustment units are associated with a punch.

In a preferred embodiment, the at least one adjustment unit is connected to the first punching element releasably. This has the advantage that the adjustment units can be replaced individually and that they are generally independent of the life cycle of the tool. This also reduces the weight and dimensions of the first punching element.

In an advantageous development, the at least one adjustment unit remains in the punching device during a tool change of the punching elements.

It is advantageous if the releasable connection comprises a T-slot or dovetail slot in the region of the first punching element and a matching extension of the adjustment unit. This makes it possible to move the adjustment unit while it is connected to the first punching element, or vice versa.

The extension of the adjustment unit can be a T-slot nut, a carriage or a bolt that interacts form-fittingly with the T-slot or dovetail slot.

In a preferred embodiment, the T-slot or dovetail slot extends perpendicular to the direction of travel of the blister strip and the first punching element is displaceable relative to the at least one adjustment unit in a direction perpendicular to the punching direction and perpendicular to the direction of travel of the blister strip.

The punching device is usually used in a blister packaging machine. Blister packaging machines generally comprise a forming station for forming the blister cavities in a forming film, a filling station for filling the formed blister cavities with products, a sealing station for sealing a cover film onto the formed film web filled with products, and a punching device.

### BRIEF DESCRIPTION OF THE DRAWINGS

FIG. 1 is a sectional view, perpendicular to the direction of travel of the blister strip, of a first embodiment of the punching device in an open position;

FIG. 2 is a sectional view, perpendicular to the direction of travel of the blister strip, of the punching device from FIG. 1 in a closed punching position, wherein two punches are retracted into an offset position in which they do not come into contact with the blister strip;

FIG. 3 is a sectional view, in the direction of travel of the blister strip, of the punching device along the line of section A-A from FIG. 2;

FIG. 4 is a sectional view, perpendicular to the direction of travel of the blister strip, of a second embodiment of the punching device in an open position;

FIG. 5 is a sectional view, perpendicular to the direction of travel of the blister strip, of the punching device from FIG. 4, in which an adjustment unit for a punch is adjusted horizontally;

FIG. 6 is a sectional view, in the direction of travel of the blister strip, of the punching device according to the line of section B-B from FIG. 5;

FIG. 7 is a sectional view, in the direction of travel of the blister strip, of the punching device according to the line of section B-B from FIG. 5, but during a punching stroke of the punching device;

FIG. 8 is a sectional view, perpendicular to the direction of travel of the blister strip, of a third embodiment of the punching device in an open position;

FIG. 9 is a sectional view, perpendicular to the direction of travel of the blister strip, of details of an embodiment of the punching device;

FIG. 10 is a sectional view, in the direction of travel of the blister strip, along the line of section C-C from FIG. 9; and

FIG. 11 is a front view of a punch set from FIGS. 9 and 10 with the associated bushes.

### DETAILED DESCRIPTION

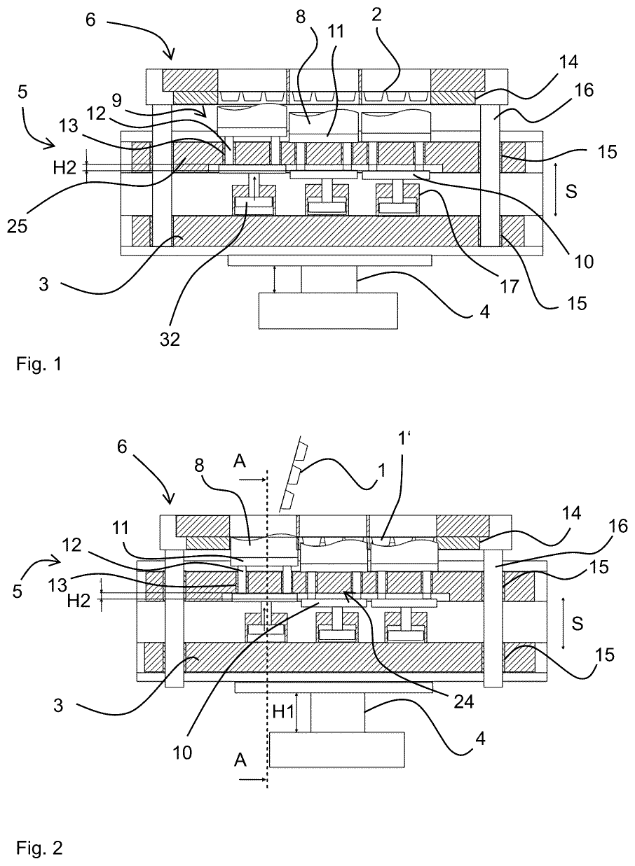

FIG. 1 shows a first embodiment of a punching device for selectively punching blister packs 1 (see FIG. 2) from a blister strip 2 in an open position. The punching device comprises a drive 4, a lifting table 3 and a first and a second punching element 5, 6. In the example shown, the first punching element 5 is arranged below the second punching element 6. However, this can also be the other way round. It is additionally conceivable that the punching device is oriented at an angle or horizontally.

The lifting table 3 is continuously moved back and forth in a punching direction S by a drive 4 of the punching device with a predetermined stroke H1 (FIG. 2) in order to generate a defined punching movement of the first punching element 5. The punching device constantly alternates here between the open position and a closed position in which the punching can take place.

Here, the lifting table transmits the movement to the first punching element 5 so that the punches 8 of the first punching element 5 move relative to the second punching element 6. The stroke H1 is typically between 20 mm and 50 mm.

The lifting table 3 and the first punching element 5 have guides aligned with each other in order to guide the lifting table 3 together with the first punching element 5 in the continuous back and forth movement in the punching direction S relative to the second punching element 6. The guides of the lifting table 3 and the first punching element 5 each have bushes 15, which are guided along the guide columns 16, which are fixedly connected to the second punching element 6 and a machine frame, not shown, of the punching device. More precisely, guide columns 16 are arranged in corner regions of the second punching elements 6 and first penetrate the bush 15 of the base plate 25 of the first punching element 5 and then the bush 15 of the lifting table 3. By guiding the lifting table 3 and the first punching element 5 together along the guide columns 16, they are precisely aligned with the second punching element 6 and guided with sufficient rigidity. The guide columns 16 and the bushes 15 are dimensioned in such a way that a tilting of the lifting table 3 and of the first punching element 5 is prevented.

The lifting table 3 and the first punching element 5 are fixedly connected to each other so that the stroke H1 of the drive 4 is fully transferred to the first punching element 5. Accordingly, the stroke H1 of the drive 4 is equal to the stroke of the lifting table 3 and the first punching element 5.

In the example shown, the second punching element 6 is stationary. However, it is also conceivable that both punching elements 5, 6 move relative to each other or that only the second punching element 6 moves relative to the first, then stationary, punching element 5.

The first punching element 5 has a base plate 25 and also a plurality of punch sets 9, which move back and forth together with the first punching element 5 and correspondingly with the lifting table 3 and the base plate of the first punching element 5.

The punch sets 9 each comprise a punch 8, punch guide means 12 and an actuating plate 10. The punch guide means 12 penetrate here the base plate 25 of the first punching element 5 along the punching direction S, wherein the punch 8 and the actuating plate 10 are arranged on opposite sides of the base plate 25 of the lower punching element 5 in the punching direction 10. Furthermore, the punch set 9 has a punch carrier plate 11 between the punch guide means 12 and the punch 8. The punch guide means 12 are formed, for example, by guide columns that form a linear guide in co-operation with bushes 13 in the base plate 25.

The punch 8 is releasably fastened to the punch carrier plate 11 in a frictionally engaged an/or form-fitting fashion. The punch guide means 12 are connected to the punch carrier plate 11 on the side thereof facing away from the punch 8. In an embodiment not shown, the punch carrier plate 11 can be dispensed with, so that the punch guide means 12 are connected directly to the punch 8.

Each bush 13 is fastened in the base plate 25 of the first punching element 5 and enables a linear movement of the punch set 9 along the punch guide means 12 in the punching direction S. In this embodiment, the punch sets 9 are each provided with four punch guide means 12, which are arranged in the corner regions of the punch carrier plate 10 or the actuating plate 10. Due to this arrangement, the punch guides enable precise guidance of the punch set 9. Furthermore, any number of punch guides can generally be provided for each punch set 9 in order to improve the guidance of the punch 8.

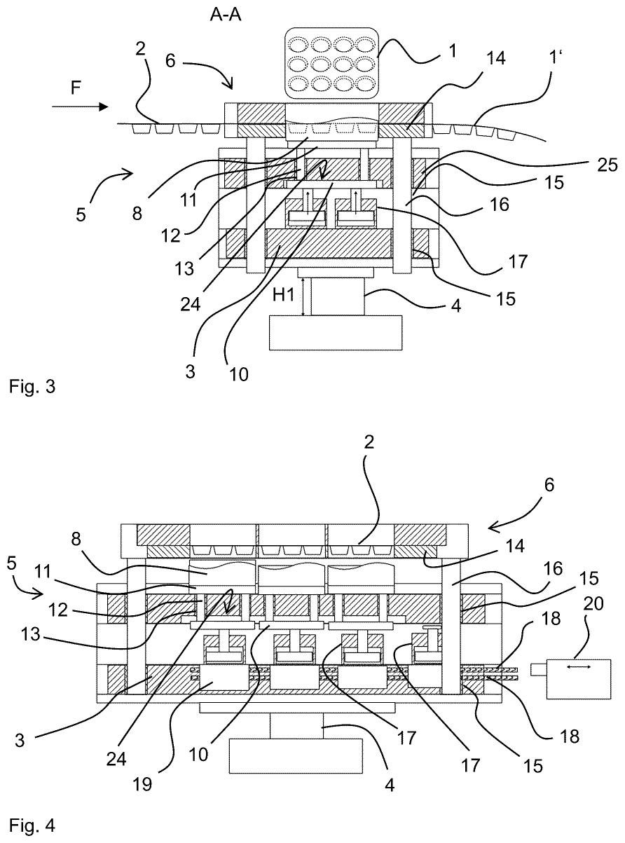

The second punching element 6 has a strip guide, which is configured to guide a filled and sealed blister strip 2 in a clocked fashion in the feed direction or direction of travel F of the blister strip (see FIG. 3). The second punching element 6 has a die 14 with recesses, which die interacts with the associated punches 8 of the first punching element 5. In addition, output openings are provided on the side of the die facing away from the first punching element 5 and make it possible to remove punched-out blister packs 1 from the punching device. The removal of the punched-out blister packs 1 is only shown schematically in FIGS. 2 and 3. A transfer device, not shown, can be used for the removal and transfers the blister packs 1 to the further processing means, for example a transport means for the blister packs 1. For this purpose, the transfer device can, for example, have individually controllable suction grippers, which engage with the cover film of the blister packs 1.

The punch 8 is guided precisely into the die 14 of the second punching element 6 using the plurality of punch guides. Furthermore, the punch guides prevent tilting of the punch 8 in the die 14. The number of punch guides of each punch set 9 can be suitably selected to suit a punching format and the dimensions of the punch 8.

The first punching element 5 and the lifting table 3 are spaced apart from each other in the punching direction S, so that a free space is formed between them. Adjustment units 17 are provided in the space between the lifting table 3 and the first punching element 5 and can be adjusted by an offset height H2 and thus enable each punch set 9 or each punch 8 to be adjusted in the punching direction S by this offset height H2. For this purpose the adjustment unit 17 is connected to the punch carrier plate 10 and the lifting table 3 in a suitable fashion. The punching force is transmitted from the lifting table 3 to the respective punch sets 9 or punches 8 via the adjustment units 17. The offset height H2 is typically generally between 5 mm and 10 mm.

Each adjustment unit 17 is individually controllable, so that each punch set 9 or each punch 8 can be adjusted by the predetermined offset height H2 from an operating position (punch 8 is deployed) into a retracted offset position (punch 8 is retracted). The adjustment units 17 are formed here as pneumatic cylinders, preferably double-acting, with a force transmission element 32 in the form of a piston. In alternative embodiments, they can also be formed as hydraulic cylinders, lifting magnets or similarly acting mechanical, electrical or fluidic adjustment units.

The adjustment units 17 must selectively adjust the punches 9 on account of the continuous movement of the drive 4 during the recurring stroke H1. The adjustment must be synchronized with the drive 4 of the punching device in such a way that the adjustment of the adjustment units 17 into the offset position takes place in a predetermined stroke range in the punching direction S, in which no contact with the blister strip 2 can occur, regardless of the position of the punch set 9 or the punch 8.

The adjustment of the adjustment units 17 is initiated by a control unit of the packaging machine (not shown), in which the punching device is integrated, wherein the control unit is further coupled to a quality assurance system of the packaging machine. If the quality assurance system detects defects in a portion of the blister strip 2 (missing filling of the blister cavities, etc.), the control unit causes the punch set 9 or the punch 8 to be moved to the offset position, whereupon the corresponding defective position of the blister strip is not punched out from the blister strip 2 in the form of blister packs 1, but remains in it. The remaining grid of the blister strip 2 with the defective blister packs 1′ is then disposed of.

In FIG. 1, the left punch set 9 is in the operating position, while the centre and right punch set 9 are in the offset position. In this embodiment, the offset of the punch set 9 in the punching direction S is defined by the distance between the punch carrier plate 11 and the actuating plate 10 and the thickness of the base plate 25 or the height of the bushes 13 of the first punching element 5 in the punching direction S. Depending on the general conditions, the offset height H2 can be set by design.

According to present embodiment, the punch set 9 or the punch 8 is moved exclusively between two positions: the operating position and the offset position. No punching is performed when the punch set 9 is in the offset position, and punching is performed when the punch set 9 is in the operating position.

FIG. 2 illustrates this relationship. It shows the punching device from FIG. 1 in a closed position, in which a blister pack 1 is selectively punched out from the blister strip 2 or not, depending on the positioning of the punch set 9 or the punch 8.

It is further provided that the first and second punching element 5, 6 are exchangeable, wherein the lifting table 3 and the adjustments units 17 remain in the punching device when the punching elements 5, 6 are changed.

FIG. 3 shows a sectional view along the line of section A-A according to FIG. 2. The cutting edge of the punch 8 penetrates the blister strip 2 in the punching direction S, so that a blister pack 1 is punched out and can be removed from the punching device. It can also be seen that two adjustment units 17 are arranged one behind the other in the direction of travel F of the blister strip 2 and jointly adjust a punch set 9 or a punch 8 in the punching direction S.

In an embodiment not shown, it is likewise conceivable to arrange several punch sets 9 one behind the other in the direction of travel of the blister strip in order to increase the punching capacity of the punching device.

In general, different punching elements 5, 6 can be used in a punching device, depending on the blister pack format. One or more adjustment units 17 can be associated with each punch set 9. It is advantageous if the adjustment units 17 are dimensioned in such a way that they do not exceed the size of the smallest blister pack format to be processed.

The adjustment units 17 therefore preferably have a width and/or length of no more than 60 mm perpendicular to or in the direction of travel of the blister strip. The height of the adjustment units 17 themselves is selected to be as low as possible in the punching direction S in order to reduce the overall height of the punching device. The height of an adjustment unit 17 is typically between 70 mm and 90 mm.

FIG. 4 shows a second embodiment of the punching device as a modification of the first embodiment from FIG. 1. In this embodiment, the punching device has many identical features, as explained previously in relation to the first embodiment. Identical reference signs denote identical elements. In the following, therefore, only additional features or features that differ from the first embodiment will be discussed.

In FIG. 4, four adjustment units 17 are provided, which can be adjusted in a direction perpendicular to the direction of travel F of the blister strip and perpendicular to the punching direction S in order to enable an adaptation to different formats of the blister strip or the blister packs. The adjustment units 17 are preferably adjusted in the direction perpendicular to the direction of travel F of the blister strip and perpendicular to the punching direction S in such a way that they are arranged symmetrically with respect to the punches 8.

In FIG. 4, an adjustment unit 17 can also be seen on the right-hand side, which is in a parked position and does not interact with a punch set 9. Depending on the number and size of the punch set 9 or the punches 8, there may be none, one, or a plurality of adjustment units 17 in the parked position. This means, for example, that a four-lane punching device can be used to punch a three-lane blister strip 2 when a punch set 9 is in the parked position.

In this embodiment, the adjustment units 17 are adjusted in the direction perpendicular to the direction of travel F of the blister strip and perpendicular to the punching direction S by means of spindles 18, which co-operate with horizontally displaceable carriages 19. There is a spindle 18 provided for each carriage. However, two carriages 19 can also be adjusted with the same spindle if they belong to the same punch 8. The carriages 19 themselves are guided in the lifting table 3 by means of a linear guide, such as a dovetail or T-slot guide, transverse to the direction of travel of the blister strip. The linear guide of the carriages 19 supports them immovably in the punching direction S, while displacement is possible in a direction which is perpendicular to the direction of travel of the blister strip and perpendicular to the punching direction. Each carriage 19 is associated with an adjustment unit 17, so that each adjustment unit 17 can be adjusted individually or several adjustment units 17 can be adjusted together by means of the spindle drive.

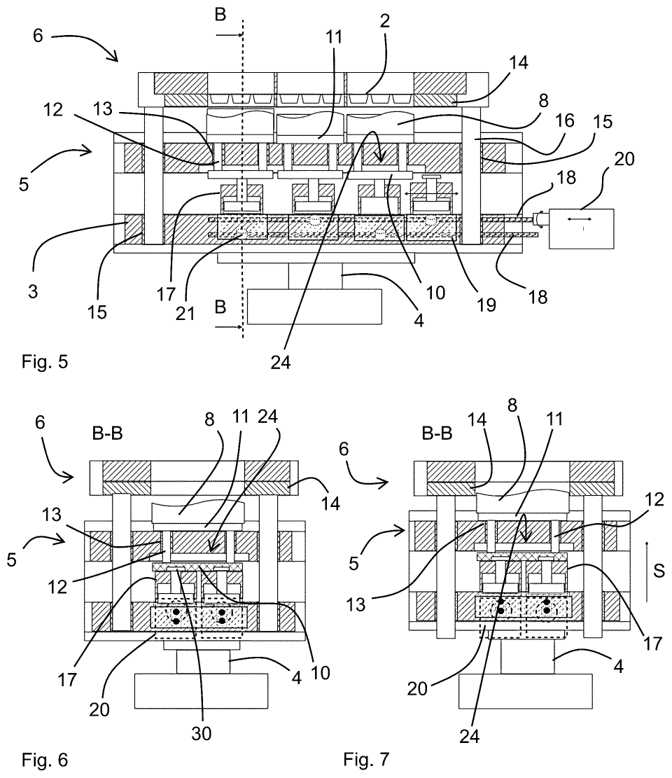

FIG. 5 shows how the spindles 18 are connected to the carriages 19. The spindles 18 pass through through-holes in the carriages 19. Without further action, they do not engage with each other. The association of a spindle 18 with a specific carriage 19 and thus the engagement of the spindle 18 with this carriage 19 is ensured by inserting a threaded segment 21 into the through-hole. Then, when the spindle 18 is rotated, the rotation of the spindle 18 is transferred to the carriage 19 and this carriage 19 is moved. The threaded segments can preferably be threaded bushes.

The spindle 18 can be driven manually, for example by means of a hand crank, or by a motor. In particular, each spindle 18 can be associated with a separate drive 20, for example in the form of a servomotor, which enables precise, preferably controlled adjustment of the respective adjustment units 17. Furthermore, a drive 20 can also be associated with a plurality of spindles 18. It is then necessary to decouple the drive 20 from one spindle 18 and couple it to another spindle 18.

If a separate drive 20 is associated with each spindle 18, the drives 20 are fixedly connected to the lifting table 3 and move back and forth with it in the punching direction during punching operation. In the event that a drive 20 is associated with several spindles 18, the drive 20 is preferably fastened to a machine frame of the punching device and is adjustable horizontally and/or vertically relative to this or the lifting table 3 by means of an adjustment device not shown.

In principle, the adjustment units 17 with their associated carriages 19 are moved when the punching device is at a standstill and not during punching operation, usually when the punching elements 5, 6 are changed. When the punching elements 5, 6 are changed, the adjustment units 17 together with the carriages 19 and the spindles 18 remain connected to the lifting table 3.

FIGS. 6 and 7 show the lower punching element 5 along the line of section B-B from FIG. 5 in the open position and in the closed punching position. In both figures, however, the punch set 9 or the punch 8 is in the offset position, which prevents a blister pack 1 from being punched out from the blister strip 2. A further comparison between FIG. 6 and FIG. 7 shows that two drives 20 are arranged one behind the other in the direction of travel of the blister strip.

In FIG. 6, the two drives 20 are associated with the two upper spindles 18, while in FIG. 7 the two drives 20 are associated with the two lower spindles 18. The drives 20 remain in the same position in the punching direction S, while the lifting table 3 including the first punching element 5 in FIG. 7 is moved manually upward in the punching direction S, which is why the two drives 20 can also be coupled to the two lower spindles 18.

Between the two states of FIG. 6 and FIG. 7, the drives 20 must be decoupled from the lower spindles 18 and recoupled with the upper spindles 18. This can be achieved by means of suitable couplings, not shown. A horizontal adjustment of the drives 20 for coupling and decoupling the drives 20 with the respective spindles 18 is also conceivable here.

FIGS. 6 and 7 further show that two adjustment units 17 are associated with a punch set 9 in the direction of travel F of the blister strip and are arranged symmetrically in relation to the punch 8. In addition, FIGS. 6 and 7 each show two T-slots 22 arranged in the actuating plate 10 perpendicular to the direction of travel F of the blister strip, which slots cooperate with corresponding extensions 30 of the adjustment units 17 and thus form a form-fitting connection in the punching direction S. In addition, the T-slots 22 enable the adjustment units 17 to be adjusted transversely to the direction of travel of the blister strip, while the actuating plate 10 of the punch set 9 is connected to the adjustment units 17.

Instead of a T-slot 22, another linearly displaceable, form-fitting connection can also be provided, such as a dovetail guide, wherein the extension 30 of the adjustment unit 17 is also designed in accordance with the selected connection. The form-fitting connection of the adjustment unit 17 to the punch set 9 by means of the T-slot 22 and the extension 30 of the adjustment unit 17 ensures the force transfer from the lifting table 3 via the adjustment unit 17 in the pulling and pushing direction to the punch set 9 in the punching direction S.

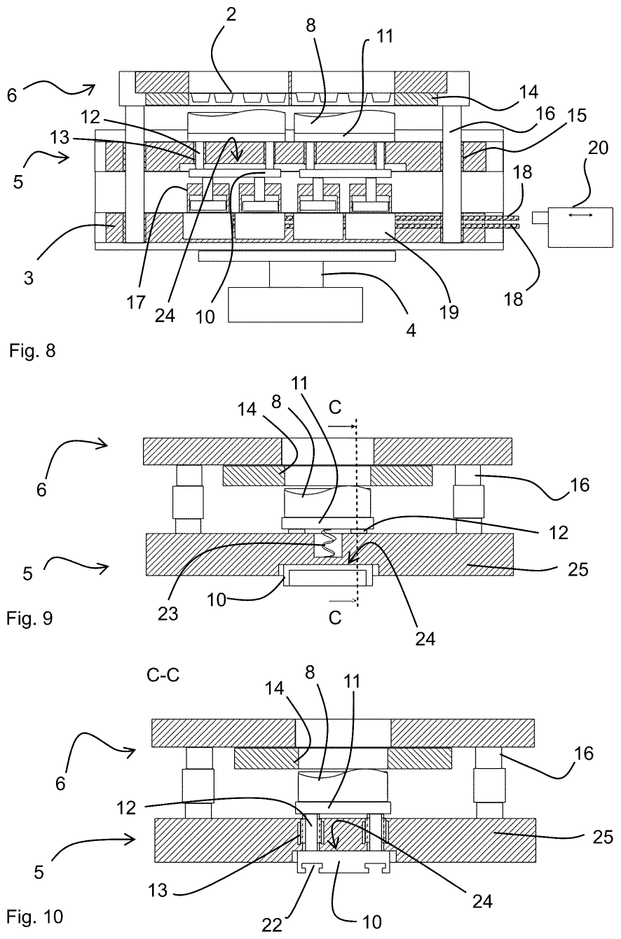

FIG. 8 shows a further modification of the embodiment from FIGS. 1 to 3. As before, only additional features or features that differ from this embodiment are discussed. With regard to all other features, reference is made to the description of FIG. 1 and FIG. 4.

In FIG. 8, two adjustment units 17 are associated with a punch set 9 or a punch 8 in a direction perpendicular to the direction of travel F of the blister strip. The adjustment units 17 are arranged symmetrically with respect to the punch set 9 in order to ensure precise guidance of the punch set 9.

FIGS. 9 and 10 show a detailed view of a further embodiment of a punching device, which is a development of the embodiments described above. Again, only the additional features are discussed.

FIG. 9 shows a first punching element 5 with a punch set 9. An elastic element 23 is provided between the punch carrier plate 11 and the base plate 25 of the first punching element 5. The elastic element 23 is shown here in particular as a spiral spring, which is mounted in an indentation in the base plate 25 and is supported against the punch carrier plate 11. The elastic element 23 pre-tensions the punch set 9 into the operating position. This causes the actuating plate 10 to be pressed against a lower surface of the base plate 25 of the first punching element 5 in the punching direction S.

The contact of the actuating plate 10 against the underside of the base plate 25 simultaneously enables the punch set 9 to be aligned in the operating position. Several elastic elements 23 can also be provided between the punch carrier plate 11 and the base plate 25 of the first punching element 5 in order to exert a desired, distributed pre-tensioning force on the punch set 9.

The underside of the base plate 25 of the first punching element 5 can additionally have specially manufactured punch set stops 24, which come into contact with the actuating plate 10 in the pre-tensioned state. These punch set stops 24 can come into contact with the actuating plate 10 as line contacts and/or point contacts. In addition, the punch set stops 24 can be made of a different material than the actuating plate 10 and can be introduced into the base plate 25 of the first punching element 5, for example into a recess. In this way, an optimised material pairing can be selected between the punch set stops 24 and the actuating plate 10, because the material of the punch set stops 24 can be selected to be different from the material of the base plate 25.

The punch set stop 24 or the stop surface of the base plate 25 of the first punching element 5, together with the actuating plate 10, ensures a precise alignment of the punch 8 in a direction perpendicular to the direction of travel of the blister strip, in the direction of travel F of the blister strip, and also in the punching direction S. The cutting gap between the punch 8 and the die 14 is usually in the micrometre range, which is why it is extremely important to prevent the punch set 9 or the punch 8 from tilting, in order to protect the punching elements 5, 6 from damage. The actuating plate 10, the punch set stops 24 and the elastic elements 23 for pre-tensioning the punch set 9 additionally stiffen the punch set 9 in the operating position for this purpose.

Furthermore, the elastic elements 23 also help to transfer the punching force, which relieves the adjustment units 17 somewhat when punching in the operating position. However, when moving the punch set 9 into the offset position, the restoring force of the elastic elements 23 must be overcome by the adjustment units 17. The pre-tensioning of the punch set 9 by means of elastic elements 23 also ensures that the punch sets 9 are always in the operating position when the adjustment units 17 are out of operation or are not connected to the punch sets 9, for example when the punching elements 5, 6 are changed or in the event of a defect in the adjustment units 17 themselves.

FIG. 10 is a sectional view along the line of section C-C from FIG. 9. The actuating plate 10 has two T-slots 22, which extend transversely to the direction of travel of the blister strip. The T-slots 22 extend completely across the width of the actuating plate 10.

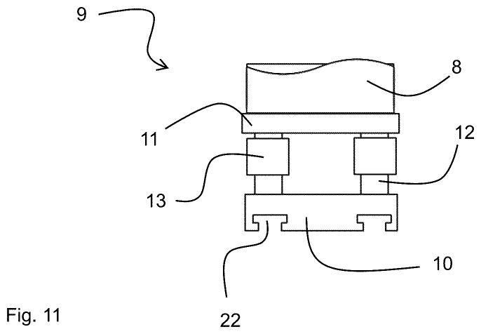

FIG. 11 is an enlarged front view of the punch set 9 from FIGS. 9 and 10.

The punch sets 9 shown in FIGS. 9 to 11 can be used in any of the embodiments described above.

The force transmission element 32 can generally also be formed as a pin or spindle adjustable in the punching direction S.

The punching elements 5, 6 are usually connected to form one part in such a way that together they are referred to as a punching tool and are also provided in this form as a spare part.

Lastly, it should be noted that, generally, features of the individual embodiments can be combined with each other.

1. A punching device for punching out blister packs from a blister strip, the punching device comprising:
at least a first and a second punching element, wherein the first punching element has at least one punch and the second punching element has a die;
wherein the first and/or the second punching element is movable back and forth in a punching direction in such a way that the punching device alternately assumes an open position and a closed position;
wherein the punching device furthermore has, for each punch, at least one adjustment unit which is associated with said punch and which is configured to move said punch, in addition to the movement of the at least one punching element, in the punching direction between an operating position and an offset position in such a way that said punch is arranged further away from the second punching element in the offset position than in the operating position; and
wherein the at least one adjustment unit has a force transmission element, which is adjustable in the punching direction in order to move said punch between the operating position and the offset position.

2. The punching device according to claim 1, wherein the force transmission element is pneumatically adjustable.

3. The punching device according to claim 2, wherein the at least one adjustment unit has a pneumatic cylinder which includes the force transmission element in the form of a piston.

4. The punching device according to claim 1, wherein the force transmission element is a piston, a spindle or a pin.

5. The punching device according to claim 1, wherein a magnitude of a stroke of the force transmission element deviates at most by 20% from an offset height of the associated punch between the operating position and the offset position.

6. The punching device according to claim 1, wherein the at least one adjustment unit is arranged in the punching direction between a lifting table of the punching device and a base plate of the first punching element.

7. The punching device according to claim 6, wherein the at least one adjustment unit is fastened to a lifting table of the punching device or integrated therein.

8. The punching device according to claim 1, wherein a stroke of the first punching element between the open position and the closed position of the punching device is between 20 mm and 50 mm.

9. The punching device according to claim 1, wherein an offset height between the operating position and the offset position of a punch, brought about by the movement of the adjustment unit, is between 5 mm and 10 mm.

10. The punching device according to claim 1, further comprising a plurality of adjustment units one behind the other in the direction of travel of the blister strip and/or next to each other perpendicular to the direction of travel of the blister strip.

11. The punching device according to claim 1, wherein each adjustment unit is individually controllable.

12. The punching device according to claim 1, wherein the at least one adjustment unit is releasably connected to the first punching element.

13. The punching device according to claim 12, wherein the at least one adjustment unit remains in the punching device during a tool change of the punching elements.

14. The punching device according to claim 12, wherein the releasable connection comprises a T-slot or dovetail slot in the region of the first punching element and a matching extension of the adjustment unit.

15. The punching device according to claim 14, wherein the T-slot or dovetail slot extends perpendicular to the direction of travel of the blister strip, and the first punching element is displaceable relative to the at least one adjustment unit in a direction perpendicular to the punching direction and perpendicular to the direction of travel of the blister strip.

16. A blister packaging machine comprising:
a punching device for punching out blister packs from a blister strip, wherein the punching device comprises at least a first and a second punching element, wherein the first punching element has at least one punch and the second punching element has a die;
wherein the first and/or the second punching element is movable back and forth in a punching direction in such a way that the punching device alternately assumes an open position and a closed position;
wherein the punching device furthermore has, for each punch, at least one adjustment unit which is associated with said punch and which is configured to move said punch, in addition to the movement of the at least one punching element, in the punching direction between an operating position and an offset position in such a way that said punch is arranged further away from the second punching element in the offset position than in the operating position; and
wherein the at least one adjustment unit has a force transmission element, which is adjustable in the punching direction in order to move said punch between the operating position and the offset position.
